(19) United States
(12) Patent Application Publication
(10) Pub. No.: US 2002/0175738 A1
(43) Pub. Date: Nov. 28, 2002

(54) Method and apparatus for reducing leakage current and improving high frequency isolation of mos switch in off state

(75) Inventor: Sasan Cyrusian, Scotts Valley, CA (US)

Correspondence Address: BRINKS HOFER GILSON & LIONE, P.O. BOX 10395, CHICAGO, IL, 60611, US

(73) Assignee: Infineon Technologies North America Corp.

(21) Appl. No.: 09/865,331

(22) Filed: May 25, 2001

(51) Int. Cl. G06G 7/18

(52) U.S. Cl. 327/337

(57) ABSTRACT

A method and apparatus is disclosed for minimizing leakage current through a storage switch and improving the off state isolation of the switch from high frequency input fluctuations. Two separate charge stores, a help store and a storage store, are provided which are charged simultaneously when charge is to be stored in the storage switch. The charge stores are maintained on either side of a control switch. The charge differential across the control switch is therefore minimized, minimizing the leakage current from the storage store. Further, switch isolation is improved by the formation of a cascaded capacitive voltage divider from the combination of the help switch and help store and the storage switch and storage store.

### BACKGROUND

Computer hard disk drives, also known as fixed disk drives or hard drives, have become a de facto standard data storage component of modem computer systems and are making further inroads into modern consumer electronics as well. Their proliferation can be directly attributed to their low cost, high storage capacity and high reliability, in addition to wide availability, low power consumption, high data transfer speeds and decreasing physical size.

These disk drives typically consist of one or more rotating magnetic platters encased within an environmentally controlled housing that further includes the electronics and mechanics to read and write data and interface with other devices. Read/write heads are positioned above each of the platters, and typically on each face, to record and read data. The electronics of a hard disk drive are coupled with these read/write heads and include numerous components to control the position of the heads and generate or sense the electromagnetic fields representing data. These components receive data from a host device, such as a personal computer, and translate that data into magnetic encodings written onto the disk platters by the heads. Further, when a host device requests data from the drive, the electronics locate the desired data, sense the magnetic encodings which represent that data and translate those encodings back into the binary digital information. Further, error detection and correction algorithms are applied to ensure accurate storage and retrieval of data.

One area in which significant advancements have been made has been in the area of read/write head technology and the methods of interpreting the magnetic fluctuations sensed by these heads. The read/write head, of which a typical hard disk has several, is the interface between magnetic platters and the disk drive electronics. The read/write head actually reads and writes the magnetically encoded data as areas of magnetic flux on the platters. Data, consisting of binary 1's and 0's, are encoded by sequences of the presence or absence of flux reversals recorded or detected by the read/write head. A flux reversal is a change in the magnetic flux in two contiguous areas of the disk platter. Traditional hard drives read data off the platters by detecting the voltage peak imparted in the read/write head when a flux reversal passes underneath the read/write head as the platters rotate. This is known as “peak detection.” However, increasing storage densities require reduced peak amplitudes and better signal discrimination and higher platter rotational speeds are pushing the peaks closer together thus making peak detection more difficult to accomplish.

Magneto-resistive (“MR”) read/write heads have increased sensitivity to sense smaller amplitude magnetic signals and with increased signal discrimination to address some of the problems with increasing storage densities. In addition, another technology, known as Partial Response Maximum Likelihood (“PRML”), has been developed to further address the problems with peak detection as densities and rotational speeds increase. Borrowed from communications technology, PRML is an algorithm implemented in the disk drive electronics to interpret the magnetic signals sensed by the read/write heads. PRML-based disk drives read the analog waveforms generated by the magnetic flux reversals stored on the disk. However, instead of looking for peak values to indicate flux reversals, PRML-based drives digitally sample this analog waveform (the “Partial Response”) and use advanced signal processing technologies to determine the bit pattern represented by that wave form (the “Maximum Likelihood”). This technology, in conjunction magneto-resistive (“MR”) heads, have permitted manufacturers to further increase data storage densities. PRML technology further tolerates more noise in the sensed magnetic signals, permitting the use of lower quality platters and read/write heads which increases manufacturing yields and lowers costs.

With many different drives available from multiple manufacturers, hard disk drives are typically differentiated by factors such as cost/megabyte of storage, data transfer rate, power requirements and form factor (physical dimensions) with the bulk of competition based on cost. With most competition between hard disk drive manufacturers coming in the area of cost, there is a need for enhanced hard disk drive components which prove cost effective in increasing supplies and driving down manufacturing costs all while increasing storage capacity, operating speed, reliability and power efficiency.

### SUMMARY

The present invention is defined by the following claims, and nothing in this section should be taken as a limitation on those claims. By way of introduction, the preferred embodiments described below relate to a storage switch. The storage switch comprises a charge input operative to receive a source voltage and a first switch element having a first input and a first output, the first input being coupled with the charge input. In addition, the storage switch comprises a first charge store being coupled with the first output, the first switch element being operative to control storage of charge in the first charge store from the charge input and a second switch element having a second input and second output, the second input being coupled with the first charge store and the first output. The storage switch further comprises a second charge store being coupled with the second output, the second switch element being operative to store charge in the second charge store from the charge input simultaneously with the first switch element. Wherein leakage current through the second switch element is dependent upon the voltage differential between the first and second charge stores.

The preferred embodiments further relate to a method of storing charge. In one embodiment, the method comprises closing first and second switches substantially simultaneously, the first and second switches being coupled in series, storing a first charge in a first store, the first store being coupled with an output of the first switch and an input of the second switch, storing a second charge in a second store, the second store being coupled with an output of the second switch, and opening the first and second switches substantially simultaneously.

Further aspects and advantages of the invention are discussed below in conjunction with the preferred embodiments.

### BRIEF DESCRIPTION OF THE DRAWINGS

FIG. 1A depicts a block diagram of an exemplary hard disk drive coupled with a host device.

FIG. 1B depicts a block diagram of read/write channel for use with the disk drive of FIG. 1A.

FIG. 2 depicts a schematic diagram of a MOS switch connected with a charge storage capacitor in one embodiment.

FIG. 3 depicts a schematic diagram of a MOS switch connected with a charge storage capacitor according to a first embodiment.

FIG. 4 depicts a schematic diagram of a MOS switch using transmission gates connected with a charge storage capacitor according to a second embodiment.

### DETAILED DESCRIPTION OF THE PRESENTLY PREFERRED EMBODIMENTS

The embodiments described herein relate to a PRML-based read/write channel device for hard disk drive controllers. The read/write channel is a device coupled with the read/write heads of the hard disk drive. Herein, the phrase “coupled with” is defined to mean directly connected to or indirectly connected with through one or more intermediate components. Such intermediate components may include both hardware and software based components. The read/write channel converts binary/digital data from the host device into the electrical impulses which drive the read/write head to magnetically record the data to the disk drive platters. Further, the read/write channel receives the analog waveform magnetically sensed by the read/write heads and converts that waveform back into the binary/digital data stored on the drive.

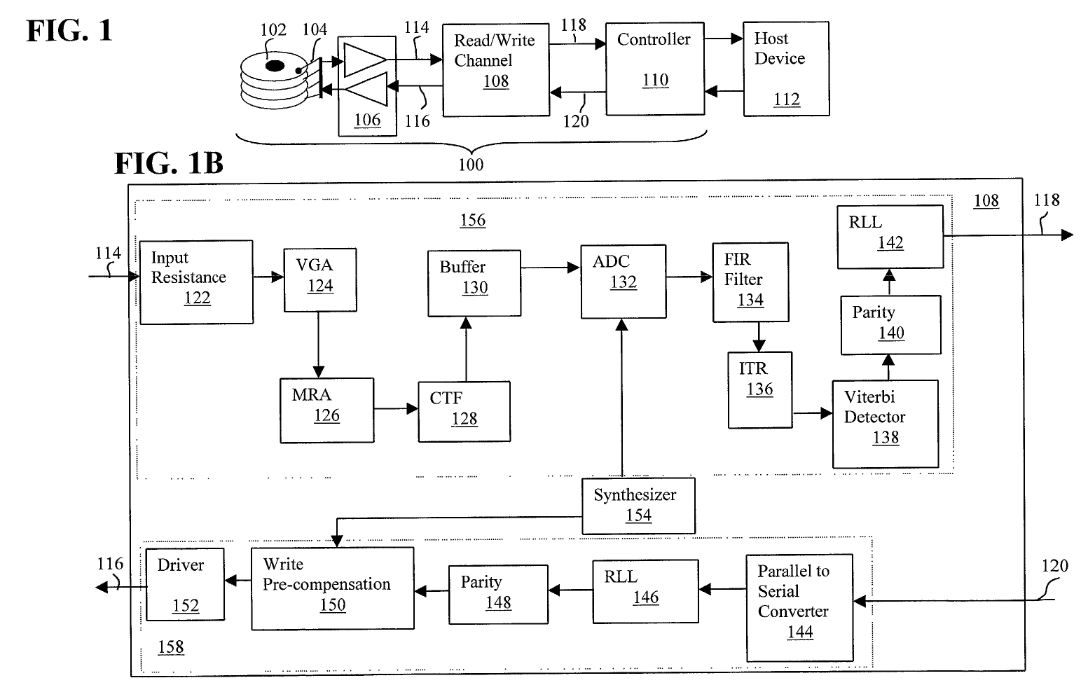

Referring to FIG. 1A, there is shown a block diagram of an exemplary hard disk drive 100 coupled with a host device 112. For clarity, some components, such as the servo/actuator motor control, are not shown. The drive 100 includes the magnetic platters and spindle motor 102, the read/write heads and actuator assembly 104, pre-amplifiers 106, a read/write channel 108 and a controller 110. The pre-amplifiers 106 are coupled with the read/write channel 108 via interfaces 114, 116. The controller 110 interfaces with the read/write channel 108 via interfaces 118, 120.

For reads from the hard disk 100, the host device 112 provides a location identifier which identifies the location of the data on the disk drive, e.g. a cylinder and sector address. The controller 110 receives this address and determines the physical location of the data on the platters 102. The controller 110 then moves the read/write heads into the proper position for the data to spin underneath the read/write heads 104. As the data spins underneath the read/write head 104, the read/write head 104 senses the presence or absence of flux reversals, generating a stream of analog signal data. This data is passed to the pre-amplifiers 106 which amplifies the signal and passes it to the read/write channel 108 via the interface 114. As will be discussed below, the read/write channel receives the amplified analog waveform from the pre-amplifiers 106 and decodes this waveform into the digital binary data that it represents. This digital binary data is then passed to the controller 110 via the interface 118. The controller 110 interfaces the hard drive 100 with the host device 112 and may contain additional functionality, such as caching or error detection/correction functionality, intended to increase the operating speed and/or reliability of the hard drive 100.

For write operations, the host device 112 provides the controller 110 with the binary digital data to be written and the location, e.g. cylinder and sector address, of where to write it. The controller 110 moves the read/write heads 104 to the proper location and sends the binary digital data to be written to the read/write channel 108 via interface 120. The read/write channel 108 receives the binary digital data, encodes it and generates analog signals which are used to drive the read/write head 104 to impart the proper magnetic flux reversals onto the magnetic platters 102 representing the binary digital data. The generated signals are passed to the pre-amplifiers 106 via interface 116 which drive the read/write heads 104.

Referring to FIG. 1B, there is shown an exemplary read/write channel 108 supporting Partial Response Maximum Likelihood (“PRML”) encoding technology for use with the hard disk drive 100 of FIG. 1A. For clarity, some components have been omitted. The read/write channel 108 is implemented as an integrated circuit using a complementary metal oxide semiconductor (“CMOS”) process at 0.18 micron. It will be appreciated that CMOS processes include processes which use metal gates as well as polysilicon gates. It will further be appreciated that other process technologies and feature sizes may used and that the circuitry disclosed herein may be further integrated with other circuitry comprising the hard disk electronics such as the hard disk controller logic. As was described, the read/write channel 108 converts between binary digital information and the analog signals representing the magnetic flux on the platters 102. The read/write channel 108 is divided into two main sections, the read path 156 and the write path 158.

The write path 158 includes a parallel-to-serial converter 144, a run-length-limited (“RLL”) encoder 146, a parity encoder 148, a write pre-compensation circuit 150 and a driver circuit 152. The parallel-to-serial converter 144 receives data from the host device 112 via interface 120 eight bits at a time. The converter 144 serializes the input data and sends the serial bit stream to the RLL encoder 146. The RLL encoder 146 encodes the serial bit stream into symbolic binary sequences according to a known run-length limited algorithm for recording on the platters 102. The exemplary RLL encoder uses a 32/33 bit symbol code to ensure that flux reversals are properly spaced and that long runs of data without flux reversals are not recorded. The RLL encoded data is then passed to the parity encoder 148 which adds a parity bit to the data. In the exemplary parity encoder 148, odd parity is used to ensure that long run's of 0's and 1's are not recorded due to the magnetic properties of such recorded data. The parity encoded data is subsequently treated as an analog signal rather than a digital signal. The analog signal is passed to a write pre-compensation circuit 150 which dynamically adjusts the pulse widths of the bit stream to account for magnetic distortions in the recording process. The adjusted analog signal is passed to a driver circuit 152 which drives the signal to the pre-amplifiers 106 via interface 116 to drive the read/write heads 104 and record the data. The exemplary driver circuit 152 includes a pseudo emitter coupled logic (“PECL”) driver circuit which generates a differential output to the pre-amplifiers 106.

The read path 156 includes an attenuation circuit/input resistance 122, a variable gain amplifier (“VGA”) 124, a magneto-resistive asymmetry linearizer (“MRA”) 126, a continuous time filter (“CTF”) 128, a buffer 130, an analog to digital converter (“ADC”) 132, a finite impulse response (“FIR”) filter 134, an interpolated timing recovery (“ITR”) circuit 136, a Viterbi algorithm detector 138, a parity decoder 140 and a run-length-limited (“RLL”) decoder 142. The amplified magnetic signals sensed from the platters 102 by the read/write head 104 are received by the read/write channel 108 via interface 114. The analog signal waveform representing the sensed magnetic signals is first passed through an input resistance 122 which is a switching circuit to attenuate the signal and account for any input resistance. The attenuated signal is then passed to a VGA 124 which amplifies the signal. The amplified signal is then passed to the MRA 126 which adjusts the signal for any distortion created by the recording process. Essentially, the MRA 126 performs the opposite function of the write-pre-compensation circuit 150 in the write path 158. The signal is next passed through the CTF 128, which is essentially a low pass filter, to filter out noise. The filtered signal is then passed to the ADC 132 via the buffer 130 which samples the analog signal and converts it to a digital form. The digital signal is then passed to a FIR filter 134 and then to a timing recovery circuit 136. The timing recovery circuit 136 is connected (not shown in the figure) to the FIR filter 134, the MRA 126 and the VGA 124 in a feedback orientation to adjust these circuits according to the signals received to provide timing compensation. The exemplary FIR filter 134 is a 10 tap FIR filter. The digital signal is then passed to the Viterbi algorithm detector 138 which determines the binary bit pattern represented by the digital signal using digital signal processing techniques. The exemplary Viterbi algorithm detector 138 uses a 32 state Viterbi processor. The binary data represented by the digital signal is then passed to the parity decoder 140 which removes the parity bit and then to the RLL decoder 142 which decodes the binary RLL encoding symbols back into the actual binary data that they represents This data is then passed to the controller 110 via the interface 118.

The read/write channel 108 further includes a clock synthesizer 154. The clock synthesizer 154 generates the clock signals required for operating the read/write channel 108. The exemplary clock synthesizer 154 includes a phased lock look (“PLL”) (not shown) with a voltage controlled oscillator and various clock dividers to generate the necessary frequencies.

When designing integrated circuits such as the read/write channel 108, several core circuit elements or cells may be repeatedly used throughout the overall design. This makes the design process simpler and more efficient by modularizing the design and allowing the designer to re-use portions of the design for different purposes. Optimizing the operating properties, such as delay and parasitic capacitance as well as implementation costs, such as time to implement and circuit area for these circuits becomes important because each occurrence of the circuit multiplies the occurrence of these properties and costs within the overall design.

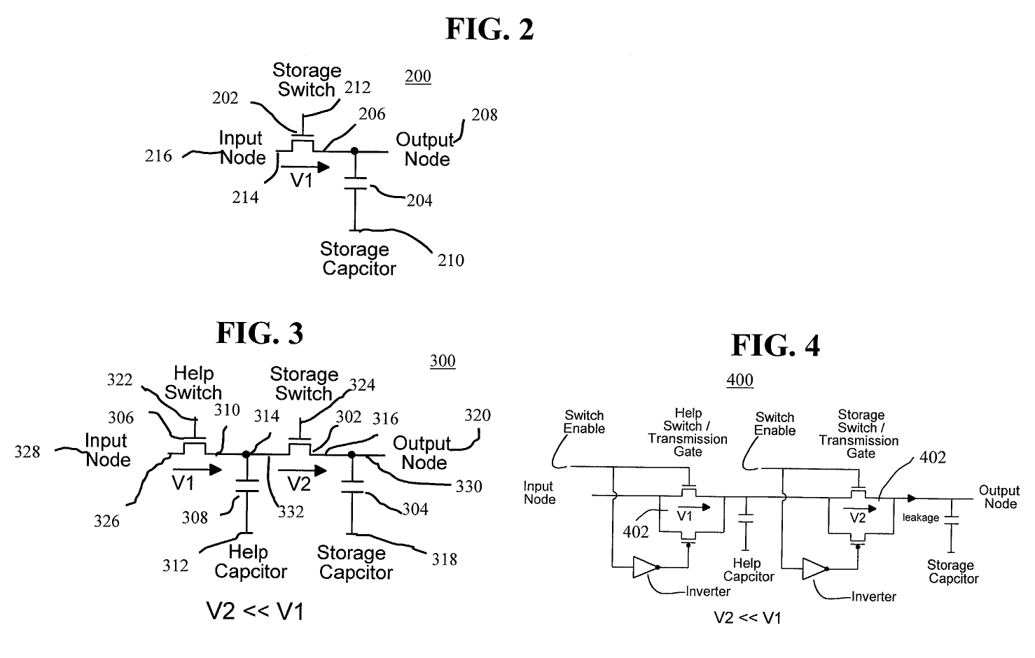

Referring to FIG. 2, there is shown one exemplary core circuit element 200 including a MOS transistor 202 and capacitor 204 connected between the drain 206 of the transistor 202 and a ground reference 210. The drain 206 of the transistor 202 is also connected to the output of the circuit 208. The input 216 of the circuit 200 is connected to the source 214 of the transistor 202. The gate 212 of the transistor 202 controls the operation of the transistor 202, effectively actuating the switch. This circuit is used to store charge on the capacitor 204 from the input 216 with the MOS transistor 202 acting as a control switch, controlled by the input on the gate 212.

For example, such circuits 200 may be used in storage applications such as a sample and hold application which samples the voltage of a signal from the input 216 and stores that sample voltage, such as is done in the variable gain amplifier 124 or in the analog to digital converter 132 wherein these circuits 200 are used to hold offset information for a particular delay period. In one embodiment, the MOS transistor 202 is an NMOS type transistor. In an alternate embodiment, the MOS transistor 202 is a PMOS type transistor or other type of transistor. The operation of MOS transistors is known and the operation of the transistors used herein will be described in terms of their ideal switch characteristics of being on/closed/short circuited or off/open/open circuited when the proper voltage is applied to the gates of the transistors.

In an exemplary operation, the MOS transistor 202 switch is turned on or closed during a sampling window in order to sample the input voltage by application of voltage to the gate 212. Closing of the switch allows the voltage to flow from the input 216 coupled with the source 214 of the transistor 202 to the drain 206 which, as described above, is connected to the capacitor 204. The input voltage passes through the transistor 202 and charges the capacitor 204. The MOS transistor 202 switch is then opened when the sampling window expires, trapping the sampled voltage in the capacitor 204.

Once the MOS transistor switch is opened, it is desirable that the stored charge remain constant. Further, it is desirable that the MOS transistor switch 202 isolate the stored charge and the output 208 from high frequency voltage fluctuations on the input/source 216 to the transistor 202. High frequency isolation is related to the amount of a high frequency signal on the input/source 216 of the switch 202 which is seen at the output/drain 206 when the switch is in the off state.

MOS transistor switches 202 can have leakage current when in an off state. It is known that the leakage current across a MOS transistor is proportional to the voltage across the two ports, i.e. input/source 214 and output/drain 206, of the switch. Further, single MOS transistor switches 202 fail to completely isolate the output/drain 206 from high frequency signals applied to the input/source 216.

The circuit 200 does provide some high frequency isolation. This is due to the parasitic capacitance between the input 216 and the output 206 of the MOS transistor of the switch 202. The parasitic capacitance of the transistor 212 in combination with the storage capacitor 204 form a capacitive voltage divider which provides some high frequency isolation of on the order of 40 dB.

Two switches coupled in series with the common node between them coupled with a third switch that connects that common node to ground during the off state of the device, i.e., a T-configuration, isolates a switch/capacitor circuit from high frequencies. This technique, however, requires two additional transistors which adds to the area of the circuit as well as the overall power consumption and parasitic capacitance of the integrated circuit, depending on how many times this circuit is used. Further, this circuit arrangement fails to prevent leakage current.

FIG. 3 shows an improved switch/capacitor circuit 300 according to a first embodiment. The circuit 300 includes an input node 328, a first MOS transistor 306, labeled as a “help switch,” a first capacitor 308, labeled as a “help capacitor,” a second MOS transistor 302, labeled as a “storage switch,” a second capacitor 304, labeled as a “storage capacitor,” and an output node 320. The first MOS transistor includes a source 326 connected to the input node 328, a gate 322 and a drain 310 connected to the help capacitor 308. The help capacitor 308 is further coupled with a ground reference 312. The storage switch transistor 302 includes a source 332 coupled with the drain 310 of the help transistor 306 and the help capacitor 312, a gate 324 and a drain 316 coupled with the storage capacitor 304 and the output node 320. The storage capacitor 304 is further coupled with a ground reference 318. The MOS transistors 302, 306 may be NMOS or PMOS transistors, as described above. Further, in an alternate embodiment, an NMOS and PMOS transistor may be coupled together in parallel to form a transmission gate. One of these transmission gates may be used to substitute for the help switch MOS transistor 302 and another transmission gate may be used to substitute for the storage switch MOS transistor. It will be appreciated that the operation of transmission gates is known in the art, and that they operate using complimentary signals to open and close the switch. Refer to FIG. 4 shows this alternative embodiment 400 using transmission gates 402.

In operation, the help switch 306 is operated simultaneously with the storage switch 302. When the storage switch 302 is opened, so is the help switch 306. During a sampling window, both switches 302, 306 are closed, allowing both the help capacitor 308 and the storage capacitor 304 to charge up. The amount of charge is equal to the capacitance of the storage and help capacitors 304, 308 and the voltage applied. When the sampling window closes, both switches 302, 306 are opened leaving the stored charge on the capacitors 304, 308.

Any leakage current through the storage switch 302 will be dependent on the voltage difference between the storage capacitor 304 and the input/source 332 of the storage switch 302. Since the input/source 332 of the storage switch 302 is coupled with the help capacitor 308, this voltage difference will be small. The help switch 306 may also suffer from leakage current. This will diminish the voltage stored in the help capacitor 308 increasing the voltage difference across the storage switch 302 and the corresponding leakage current of the storage switch 302. However, the cascaded nature of the switches 302, 306 and the help capacitor 308 may significantly reduce this degradation. Further, by appropriately sizing the help capacitor 308, the voltage change can be minimized. In one embodiment, the help capacitor 308 has 1/10 the capacitance of the storage capacitor 304. For example, if the storage capacitor 304 has a capacitance of 100 femto-Farads (“fF”) (1 femto-farad=10⁻¹⁵ Farad), the help capacitor 308 should be at least 10 femto-Farads. It will be appreciated that the exact parameters of the storage capacitor 304 are dependent upon how much charge is required to be stored for the given application.

Further, this arrangement of the circuit 300 isolates the storage capacitor 304 from high frequency fluctuations on the input 328 better than the circuit 200 of FIG. 2. In the circuit 300 of FIG. 3, two cascaded capacitive voltage dividers are formed. The first is built by the parasitic capacitance of the help switch/transistor 306 in combination with the help capacitor 308. The second capacitive voltage divider is formed by the parasitic capacitance of the storage transistor/switch 302 and the storage capacitor 304. In one embodiment, the circuit 300 provides 52 dB of isolation.

It is to be noted that suitable transistor sizes specifying channel width-to-length ratios (measured in micrometers or microns) for the transistors which make up the depicted circuits have been omitted from the figures. It will be appreciated that suitable ratios may be chosen depending on the design requirements and the capabilities and limitations of the particular integrated circuit fabrication process used for implementation of the circuit as well as the performance requirements of the specific embodiment. It is noted thought that the channel width of the transistors 302, 306 should be twice the width of the channel of the transistor 202 in FIG. 2. This equates the “on” resistance, the resistance of the switch when in the on state, of the two series transistors 302, 306 to the on resistance of the switch 202. This is important when substituting the improved circuit 300 for the circuit 200 to maintain the electrical characteristics relative to other circuits coupled with the circuit 300. For example, in one embodiment, the channel width to length ration for the transistor 202 is 1.8/.18 microns. The channel width to length ration for each of the transistors 302, 306 is 3.6/.18 microns.

It is therefore intended that the foregoing detailed description be regarded as illustrative rather than limiting, and that it be understood that it is the following claims, including all equivalents, that are intended to define the spirit and scope of this invention.

We claim:

1. A method of storing charge comprising:
(a) closing first and second switches substantially simultaneously, said first and second switches being coupled in series;
(b) storing a first charge in a first store, said first store being coupled with an output of said first switch and an input of said second switch;
(c) storing a second charge in a second store, said second store being coupled with an output of said second switch; and
(d) opening said first and second switches substantially simultaneously.

2. The method of claim 1, further comprising:
(e) maintaining a substantially small voltage difference between said input and said output of said second switch whereby leakage current through said second switch is substantially minimized.

3. The method of claim 1, wherein (b) further comprises storing said first charge in said first store, said first store comprising a first capacitor coupled with a reference, (c) further comprising storing said second charge in said second store, said second store comprising a second capacitor coupled with said reference.

4. The method of claim 3, wherein said first capacitor is characterized by a capacitance 1/10 of the capacitance of said second capacitor.

5. The method of claim 4, wherein said first capacitor has a capacitance of 10 femto-Farads, said second capacitor has a capacitance of 100 femto-Farads.

6. The method of claim 1, wherein (e) further comprises maintaining said substantially small voltage difference in the range of approximately 0.015 volts.

7. The method of claim 1, wherein said first and second switches comprise transmission gates.

8. The method of claim 1, wherein said first and second switches comprise first and second MOS transistors.

9. The method of claim 8, wherein said first and second MOS transistors are each characterized by a channel width of 3.6 microns and a channel length of 0.18 microns.

10. The method of claim 8, wherein said first and second MOS transistors are each characterized by a first channel width and together are characterized by an on resistance substantially equal to a single MOS transistor having a channel width substantially equal to ½ said first channel width.

11. The method of claim 8, wherein said first and second MOS transistors comprise PMOS transistors.

12. The method of claim 8, wherein said first and second MOS transistors comprise NMOS transistors.

13. The method of claim 1, wherein said first charge is a function of a first voltage and a first capacitance, said second charge is a function of a second voltage and a second capacitance, said first voltage being substantially the same as said second voltage.

14. The method of claim 1, wherein said first charge is characterized by a substantially s low degradation.

15. The method of claim 1, further comprising:
(f) forming a cascaded capacitive voltage divider; and
(g) isolating said output of said second switch from high frequency input fluctuations.

16. A storage switch comprising:
a charge input operative to receive a source voltage;
a first switch element having a first input and a first output, said first input being coupled with said charge input;
a first charge store being coupled with said first output, said first switch element being operative to control storage of charge in said first charge store from said charge input;
a second switch element having a second input and second output, said second input being coupled with said first charge store and said first output;
a second charge store being coupled with said second output, said second switch element being operative to store charge in said second charge store from said charge input simultaneously with said first switch element; and
wherein leakage current through said second switch element is dependent upon the voltage differential between said first and second charge stores.

17. The storage switch of claim 16, wherein said first and second charge stores comprise first and second capacitors each being further coupled with a reference.

18. The storage switch of claim 17, wherein said first capacitor is characterized by a capacitance 1/10 of the capacitance of said second capacitor.

19. The storage switch of claim 18, wherein said first capacitor has a capacitance of 10 femto-Farads, said second capacitor has a capacitance of 100 femto-Farads.

20. The storage switch of claim 16, wherein said first and second switch elements are further operative to store substantially the same charge in said first an second charge stores.

21. The storage switch of claim 16, wherein said first and second switch elements comprise transmission gates.

22. The storage switch of claim 16, wherein said first and second switch elements comprise first and second MOS transistors.

23. The storage switch of claim 22, wherein said first MOS transistor is characterized by a channel width of 3.6 microns and a channel length of 0.18 microns.

24. The storage switch of claim 22, wherein said first and second MOS transistors are each characterized by a first channel width and together are characterized by an on resistance substantially equal to a single MOS transistor having a channel width substantially equal to ½ said first channel width.

25. The storage switch of claim 22, wherein said first and second MOS transistors comprise PMOS transistors.

26. The storage switch of claim 22, wherein said first and second MOS transistors comprise NMOS transistors.

27. The storage switch of claim 16, wherein said first charge store is characterized by a substantially slow degradation.

28. The storage switch of claim 16, wherein said first and second switches are characterized by first and second parasitic capacitances, said first capacitance forming a first capacitive voltage divider with said first charge store, and said second parasitic capacitance forming a second voltage divider with said second charge store, said first voltage divider being cascaded with said second voltage divider and operative to isolate said second output from high frequency fluctuations of said charge input.

29. An apparatus for storing charge comprising:
first means for controlling storage of charge in a first charge store from a first input, said first charge store being coupled with said first means;
second means for controlling storage of charge in a second charge store, said second means being coupled with said first means in series, said second charge store being coupled with said second means; and
wherein charge stored in said first charge store maintains a substantially minimal voltage differential across said second means thereby substantially minimizing leakage current through said second means.

30. The apparatus of claim 29, further comprising means to improve high frequency isolation of said apparatus.
